(19) United States
(12) Patent Application Publication
(10) Pub. No.: US 2015/0235155 A1
(43) Pub. Date: Aug. 20, 2015

(54) SYSTEM AND METHOD FOR TRACKING THE COMPETENCY OF INDIVIDUALS

(71) Applicant: Aaron Michael McGuffin, Huntington, WV (US)

(72) Inventor: Aaron Michael McGuffin, Huntington, WV (US)

(21) Appl. No.: 14/182,360

(22) Filed: Feb. 18, 2014

(51) Int. Cl. G06Q 10/06

(52) U.S. Cl. CPC G06Q 10/0639

(57) ABSTRACT

A system for tracking the competency of individuals within an organization may include at least one user creating and accessing an account. A list of competencies, at least one specification for each competency, a plurality of informational material and at least one verification method may be provided by the at least one user. At least one individual may create and access an account. The at least one individual may view the list of competencies, at least one specification, plurality of informational material and the verification method. The at least one individual may record achievements and the system may verify the performance of the achievements by the at least one individual. The verified competency achievements may be sent to a database for analysis.

### BACKGROUND OF THE INVENTION

The present invention relates to determining competency levels and, more particularly, to a system for tracking the competency of individuals.

People who supervise others often lack sufficient evidence to determine the competency levels of those individuals. This is detrimental for determining individual strengths and weaknesses, progress in learning their trade, promotion of the individual, improvement of the organization and its services in general and public safety.

Other competency tracker inventions are built specifically for one organization only. There is no invention that allows for multiple organizations to create a personalized competency tracking system. The existing competency trackers do not take into account the variety of competencies that may be required of an organization and do not allow for facile modification of their functionality.

There is no existing invention that allows for an organization to de novo create and modify competencies for the individuals within it, support the achievement of those competencies with educational material, and then allow the individuals to track the achievement of those competencies through multiple methods on mobile devices.

As can be seen, there is a need for a system and method for tracking the competency of individuals within an organization that is modifiable, that supports the individuals with educational material, and that allows the organization and the individuals to track the achievements of these competencies through multiple methods on a mobile device application.

### SUMMARY OF THE INVENTION

In one aspect of the present invention, a method for tracking the competency of individuals within an organization comprising: prompting at least one user to create and access an account; receiving a list of competencies from the at least one user; receiving at least one specification for each competency listed in the list of competencies by the at least one user; receiving, from the at least one user, a plurality of informational material for at least one individual to study in order to complete the list of competencies; receiving, from the at least one user, at least one verification method to verify the completion of the list of competencies; prompting at least one individual to create and access an account; providing the list of competencies to the at least one individual; providing the at least one specification to the at least one individual; providing the plurality of informational material to the at least one individual; providing the at least one verification method to verify the completion of the list of competencies; receiving recordings of achievements by the at least one individual; verifying the performance of the at least one individual achievements by the at least one individual; and sending the verified competency achievements to a database.

In another aspect of the present invention, a system for tracking the competency of individuals within an organization comprising: a computer having a user interface; a program product comprising machine-readable program code for causing, when executed, the computer to perform the following process steps: prompting at least one user to create and access an account; receiving a list of competencies from the at least one user; receiving at least one specification for each competency listed in the list of competencies by the at least one user; receiving, from the at least one user, a plurality of informational material for at least one individual to study in order to complete the list of competencies; receiving, from the at least one user, at least one verification method to verify the completion of the list of competencies; prompting at least one individual to create and access an account; providing the list of competencies to the at least one individual; providing the at least one specification to the at least one individual; providing the plurality of informational material to the at least one individual; providing the at least one verification method to verify the completion of the list of competencies; receiving recordings of achievements by the at least one individual; verifying the performance of the at least one individual achievements by the at least one individual; and sending the verified competency achievements to a database.

These and other features, aspects and advantages of the present invention will become better understood with reference to the following drawings, description and claims.

### BRIEF DESCRIPTION OF THE DRAWINGS

FIG. 1 is a flow chart of an exemplary embodiment of the present invention; and

FIG. 2 is a continuation of the flow chart of an exemplary embodiment of the present invention of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a system for tracking the competency of individuals within an organization that may include at least one user creating and accessing an account. A list of competencies, at least one specification for each competency, a plurality of informational material and at least one verification method may be provided by the at least one user. At least one individual may create and access an account. The at least one individual may view the list of competencies, at least one specification, plurality of informational material and the verification method. The at least one individual may record achievements and the system may verify the performance of the achievements by the at least one individual. The verified competency achievements may be sent to a database for analysis.

The present invention may include at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The present invention may allow organizations to determine the competencies the individuals within the organization must achieve. The system may set parameters for the competencies, such as the number of times the item needs to be completed successfully, amount of time to complete the task and the like. The system may provide educational support to achieve the competencies such as the organization's manual, notes and the like, and then may allow the individual to record their completion of the competencies such as through completion of tests, uploading of pictures, videos, and the like, to their organizational leaders for verification and feedback. The system may provide a blank slate for any employer, coach, supervisor, and the like, of a team to set their competencies specifically for them, provide educational content to assist the individuals with achieving them and then allow the individual to self track their accomplishment of the competencies through their mobile device or the like in multiple ways.

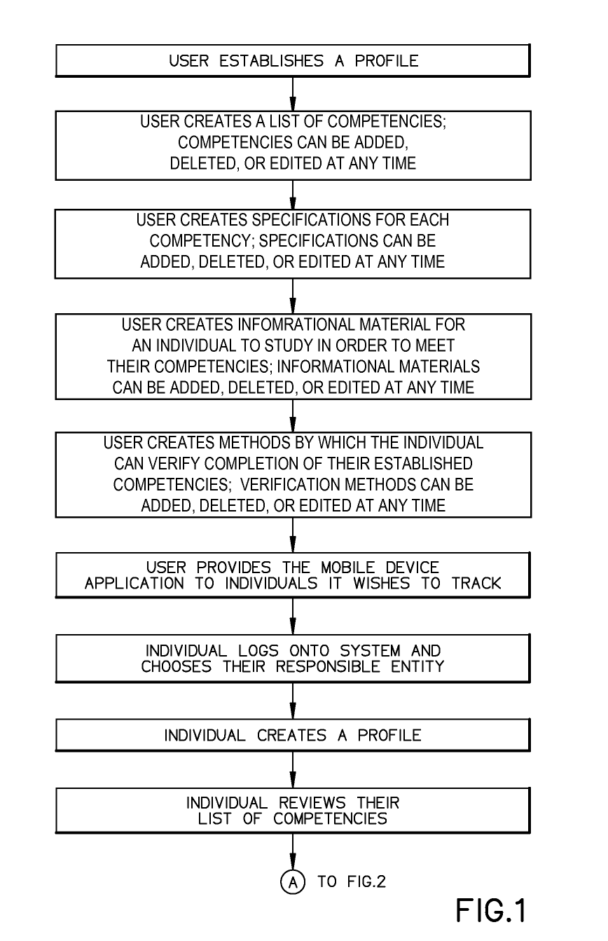

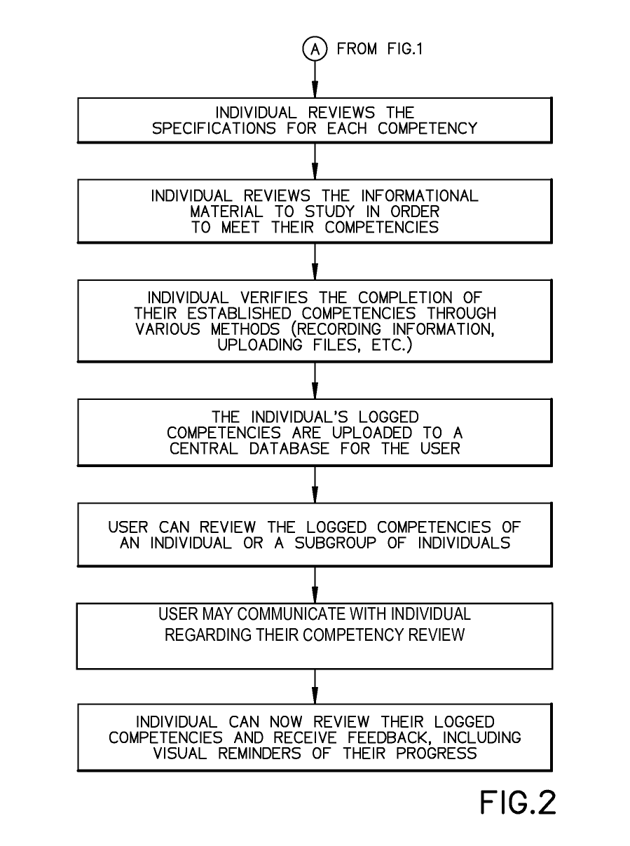

As is illustrated in FIGS. 1 and 2, the present invention may include an application. At least one user may be prompted to create and access an account on the application. In certain embodiments, the at least one user may download the application. The at least one user may provide information such as information about the company, the team, and the like. The at least one user may input a list of the competencies that may be required of employees, team members, and the like. The at least one user may then input at least one specification for each competency that may be listed in the list of competencies such as the number of times the competency has to be completed, deadlines, amounts and the like. The at least one user may upload a plurality of informational material for at least one individual to study in order to complete the list of competencies. The plurality of informational material may include the employee manual, notes, diagrams, video links and the like. The at least one user may then determine the ways the at least one individual may prove their competency through a verification method such as the completion of an exam, uploading an image, uploading a video, recording an event or the like.

The at least one individual may have access to the application. The at least one individual may create an account and may determine the responsible entity. The at least one individual may then review the list of competencies listed within the application. The at least one individual may review the at least one specification for each competency listed in the list of competencies. The at least one individual may review the informational materials that the at least one individual may access through the application. The at least one individual may review the verification method and what the at least one individual needs to accomplish in order to have completed the competency. The at least one individual may then begin to record their achievements in the application in the appropriate sections. The achievements may be such as completed twenty push-ups, uploaded PowerPoint on patient safety talk to nurses, completed on-line exam with a 92%, and the like. The at least one user may then receive the verification of the performance of the at least one individual achievements in real-time and keep track of the progress. The at least one user may analyze the at least one individual progress to review with the at least one individual at any point. In certain embodiments, the at least one user may analyze group progress to review with the team at any point. The at least one individual may receive feedback on their mobile device on their achievements, including at least one visual reminder of their progress, such as red bars turning green with achievement, and the like. The at least one user may also receive updates on the progress of the competency of the at least one individual.

A method of using the present system may include the following. An employer may want to reassure theft customers that their employees are well trained in customer service. The employer may use the system to create a list of approximately forty competencies the employees must complete before being allowed to man the phones or work the service counter. The system may then allow the employer to track the progress of theft employees in achieving the level of competence that the employer has set, and in a specific time period. The system may be accessed through the application on the mobile device without having to constantly track down the at least one individual as any information they are uploading may automatically be sent to the central database for the employer. In certain embodiments, once the employee has completed the approximately forty competencies successfully, the employer may then verify and may advertise for their customers the level of competency of their employees and back it up with the data the employee has within the database. In certain embodiments, the system may be used by a coach to help track the competency of the players. In certain embodiments, the system may be used to help self-motivated people process and track their progress. More robust competency measures may be added to a particular profession by making adjustments to the list of competencies, and specifications required to complete the competencies.

In certain embodiments, the list of competencies may include a list of ten ways to improve morale. The informational material may include a short summary on the application discussing what morale is. The at least one individual may have one option in the verification method of the competency section that may be to upload the list which, when clicked on, may provide ten free text boxes for them to complete the competency task. Notification to alert the at least one individual or the at least one user may be modified for the particular use of the system.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A method for tracking the competency of individuals comprising:
prompting at least one user to create and access an account;
receiving a list of competencies from the at least one user;
receiving at least one specification for each competency listed in the list of competencies by the at least one user;
receiving, from the at least one user, a plurality of informational material for at least one individual to study in order to complete the list of competencies;
receiving, from the at least one user, at least one verification method to verify the completion of the list of competencies;
prompting at least one individual to create and access an account;
providing the list of competencies to the at least one individual;
providing the at least one specification to the at least one individual;
providing the plurality of informational material to the at least one individual;
providing the at least one verification method to verify the completion of the list of competencies;
receiving recordings of achievements by the at least one individual;
verifying the performance of the at least one individual achievements by the at least one individual; and
sending the verified competency achievements to a database.

2. The method of claim 1, further comprising the step of sending notification of competencies due to the at least one individual.

3. The method of claim 1, further comprising the step of sending notification of the completion of competencies to the at least one user.

4. The method of claim 1, further comprising the step of providing feedback from the recordings of achievements of the competencies for viewing by the at least one individual and the at least one user.

5. The method of claim 4, wherein the feedback is in the form of at least one visual reminder of the progress of the at least one individual.

6. The method of claim 1, wherein the at least one user and the at least one individual enter the information on a portable computer.

7. The method of claim 6, wherein the portable computer is at least one of a tablet and a smart phone.

8. A system for tracking the competency of individuals comprising:
a computer having a user interface;
a program product comprising machine-readable program code for causing, when executed, the computer to perform the following process steps:
prompting at least one user to create and access an account;
receiving a list of competencies from the at least one user;
receiving at least one specification for each competency listed in the list of competencies by the at least one user;
receiving, from the at least one user, a plurality of informational material for at least one individual to study in order to complete the list of competencies;
receiving, from the at least one user, at least one verification method to verify the completion of the list of competencies;
prompting at least one individual to create and access an account;
providing the list of competencies to the at least one individual;
providing the at least one specification to the at least one individual;
providing the plurality of informational material to the at least one individual;
providing the at least one verification method to verify the completion of the list of competencies;
receiving recordings of achievements by the at least one individual;
verifying the performance of the at least one individual achievements by the at least one individual; and
sending the verified competency achievements to a database.

9. The system of claim 8, further comprising the step of sending notification of competencies due to the at least one individual.

10. The system of claim 8, further comprising the step of sending notification of the completion of competencies to the at least one user.

11. The system of claim 8, further comprising the step of providing feedback from the recordings of achievements of the competencies for viewing by the at least one individual and the at least one user.

12. The system of claim 11, wherein the feedback is in the form of at least one visual reminder of the progress of the at least one individual.

13. The system of claim 8, wherein the at least one user and the at least one individual enter the information on a portable computer.

14. The system of claim 13, wherein the portable computer is at least one of a tablet and a smart phone.
